(19) United States
(12) Patent Application Publication
(10) Pub. No.: US 2016/0343086 A1
(43) Pub. Date: Nov. 24, 2016

(54) SYSTEM AND METHOD FOR FACILITATING INTERPRETATION OF FINANCIAL STATEMENTS IN 10K REPORTS BY LINKING NUMBERS TO THEIR CONTEXT

(71) Applicant: XEROX CORPORATION, NORWALK, CT (US)

(72) Inventors: Anirban Mondal, K.R. Puram Hobli (IN); Agnes Sandor, Meylan (FR); Diana Nicoleta Popa, Grenoble (FR); Anna Stavrianou, Biviers (FR); Denys Proux, Vif (FR)

(21) Appl. No.: 14/715,998

(22) Filed: May 19, 2015

(51) Int. Cl. G06Q 40/00; G06F 17/27

(52) U.S. Cl. CPC G06Q 40/12; G06F 17/2705

(57) ABSTRACT

The present disclosure relates to a computer-implemented method, device, and computer-readable storage medium used for contextual linking information in a financial report. The method can include obtaining portions of the financial report; detecting one or more line items in the portions of the financial report based on one or more properties of the one or more line items; detecting one or more section headers in the portions of the financial report based on one or more properties of the one or more section headers; parsing, by a processor, the one or more line items and the one or more section headers that are detected; and linking the one or more line items to the one or more section headers based on the parsing.

### FIELD

One or more of the presently disclosed examples is related to analysis of financial statements.

### BACKGROUND

Financial analysis involves the use of various financial formulas and interpretations to measure the financial strengths and weaknesses of a company and to compare these strengths and weaknesses with those of other companies within an industry. Financial analysis information may be valuable to those within a company (e.g., officers, and financial managers) and to those outside of a company (e.g., investors, creditors, and security analysts).

Conventional practice relies on the financial analyst manually going through the financial statement, i.e., 10-K, 10-Q reports, or other similarly structured financial report, and trying to make inferences from them. This practice of examining the financial statements is generally error-prone due to the cumbersome manual process. What is needed is an improved method for analysis of financial reports.

### SUMMARY

In implementations, a computer-implemented method for contextual linking information in a financial report is disclosed. The method can comprise obtaining portions of the financial report; detecting one or more line items in the portions of the financial report based on one or more properties of the one or more line items; detecting one or more section headers in the portions of the financial report based on one or more properties of the one or more section headers; parsing, by a processor, the one or more line items and the one or more section headers that are detected; and linking the one or more line items to the one or more section headers based on the parsing.

In some aspects, the one or more properties of the one or more line items can comprise a table format having defined rows and columns, wherein the table format comprises a header section indicating a type of information in each column.

In some aspects, the one or more properties of the one or more section headers can comprise one or more of: section headers are in separate paragraphs and are outside of a table format; section headers do not contain multiple sentences, and section headers are not full sentences and do not contain finite verbs.

In some aspects, the detecting one or more section headers in the portions of the financial report can be based on the one or more properties of the one or more section headers, can further comprise detecting paragraphs in the portions of the financial report based on locations of paragraph markers; detecting candidate paragraphs from the paragraphs that are detected that do not contain multiple sentences; executing a parts-of-speech tagging operation on the candidate paragraphs that are detected to determine which of the candidate paragraphs contain verbs; and excluding the candidate paragraphs that are found to contain verbs.

In some aspects, the parsing the one or more line items and the one or more section headers that are detected can further comprise determining a part of speech for a word in a line item or a section header; lemmatizing the word to link the work to different forms of a same lemma; and labeling the part of speech for the word with a head tag or a modifier tag.

In some aspects, the linking the one or more line items to the one or more section headers based on the parsing can further comprise determining that section header and denomination of the line item is identical.

In some aspects, the linking the one or more line items to the one or more section headers based on the parsing can further comprise determining that entire denomination of the line header is contained in the section header.

In some aspects, the linking the one or more line items to the one or more section headers based on the parsing can further comprise determining that entire section header is contained in the line item.

In some aspects, the linking the one or more line items to the one or more section headers based on the parsing can further comprise determining that line item and the section header have common elements and contain other words; and providing a conditional link between the line item and section header.

In some aspects, the method can further comprise providing an output to a user based on the linking.

In implementations, a device is disclosed that can comprise a memory containing instructions; and at least one processor, operably connected to the memory, the executes the instructions to perform a method for contextual linking information in a financial report. The method can comprise obtaining portions of the financial report; detecting one or more line items in the portions of the financial report based on one or more properties of the one or more line items; detecting one or more section headers in the portions of the financial report based on one or more properties of the one or more section headers; parsing, by a processor, the one or more line items and the one or more section headers that are detected; and linking the one or more line items to the one or more section headers based on the parsing.

In implementations, a computer readable storage medium comprising instructions for causing one or more processors to perform a method for contextual linking information in a financial report is disclosed. The method can comprise obtaining portions of the financial report; detecting one or more line items in the portions of the financial report based on one or more properties of the one or more line items; detecting one or more section headers in the portions of the financial report based on one or more properties of the one or more section headers; parsing, by a processor, the one or more line items and the one or more section headers that are detected; and linking the one or more line items to the one or more section headers based on the parsing.

The present disclosure also provides a computer-readable medium which stores programmable instructions configured for being executed by at least one processor for performing the methods described herein according to the present disclosure. The computer-readable medium can include flash memory, CD-ROM, a hard drive, etc.

### BRIEF DESCRIPTION OF THE DRAWINGS

Various embodiments of the present disclosure will be described herein below with reference to the figures wherein:

FIG. 1 shows an example balance sheet of a firm;

FIG. 2 shows examples of a type of additional information related to specific line items that people may want to retrieve from the balance sheet of FIG. 1;

FIG. 3 depicts example architecture of the 10-K report contextual linking system, according to the present teachings;

FIG. 4 illustrates an example balance sheet and some of the linked contextual information, according to the present teachings; and

FIG. 5 illustrates an example computing device, in accordance with examples of the present teachings.

### DETAILED DESCRIPTION

The linking of numbers in a financial statement to their respective context is useful for a variety of purposes including: (a) SEC for fraud detection purposes (b) Investment banks for investment planning purposes, (c) retirement planning fund organizations for planning retirement-related investment portfolios, and (d) analysis by financial analysts.

In general, a method of contextually linking of line items with the text within financial statements is provided herein that reduces the possibility of errors/omissions as well as the chances of missing key financial irregularities in the financial statements is provided herein. Although the description below uses a 10-K report as an example financial report, the disclosure is not limited in this way. Other financial statements having a similar reporting structure could be used. This contextual linking allows readers, such as financial analysis or any interested party, to ability to navigate through the financial statement, i.e., 10-K, 10-Q reports, etc., more easily.

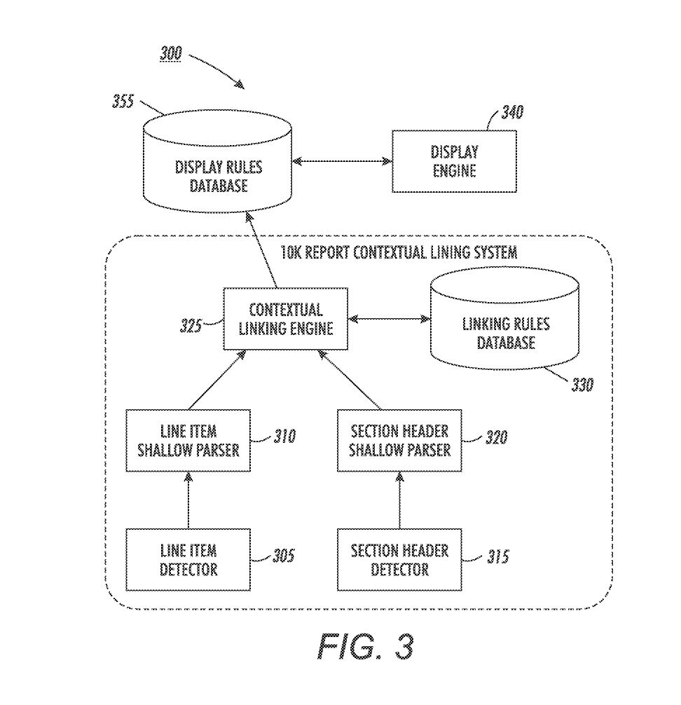

Moreover, since most firms submit an HTML version of their 10-K reports, the disclosure below will discuss this process in these terms. However, the disclosure is not limited to the financial statement in HTML. Other suitable formats can also be used, such as XML, plain text, PDF, etc. A system and method is provided herein that can be used to aid a financial analyst to identify the context within which numbers appearing in key financial parameters within the financial statement. The financial parameters include, but are not limited to, the balance sheet, the income statement, the statement of cash flows and the statement of equity. Other financial parameters can also be linked using the method provided herein. The method uses a contextual linking engine, described below with reference to FIG. 3, to identify the links between the numbers and their respective contextual information.

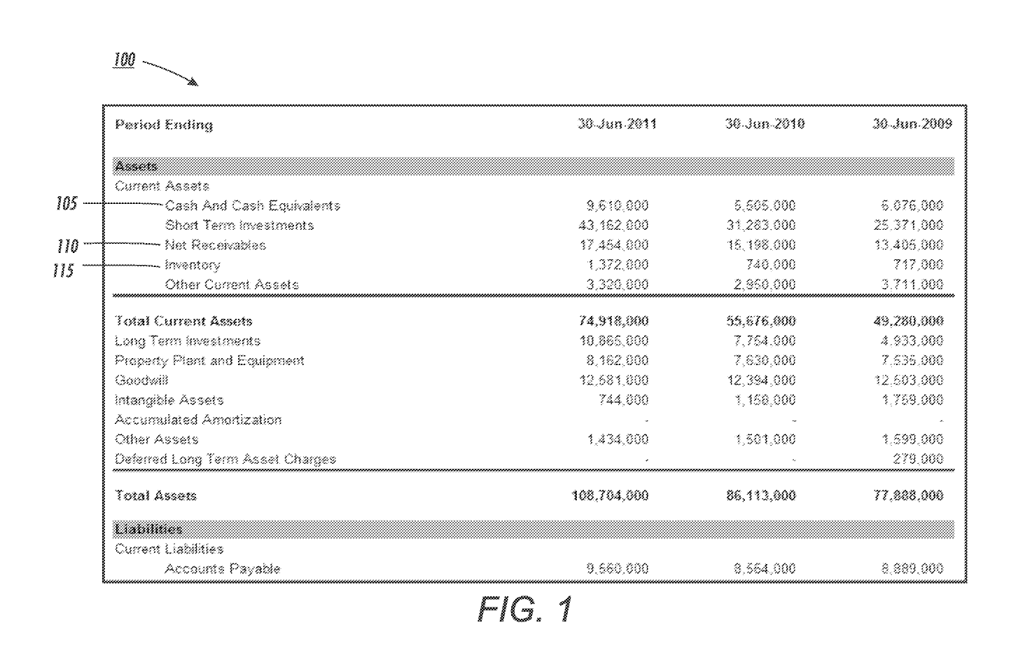

FIG. 1 provides an illustrative example of the balance sheet 100 of a given firm. In this example, the context of the numbers corresponding to each line item (e.g., “Cash and Cash equivalents” 105, Net Receivables” 110, “Inventory” 115 etc.) needs to be understood by the financial analyst for performing any kind of meaningful analysis, such as comparisons across the same firm, across multiple years, and cross-comparisons among different firms. The contextual information about the numbers corresponding to each line item is provided in the text of the 10-K annual report. Given that 10-K reports are typically extremely comprehensive and can easily span tens of pages (100-250 pages is not uncommon for the 10K reports of many firms), it becomes extremely cumbersome and time-consuming for the financial analyst to go through the entire 10-K report for linking the contextual information about a given line item to its relevant context. The challenges associated with such linking are further exacerbated by the fact that the contextual information about any given line item is often spread across different parts of the 10-K report, i.e., given a specific line item, all the relevant contextual information about it is generally not present in a contiguous manner in any specific part of the 10-K report.

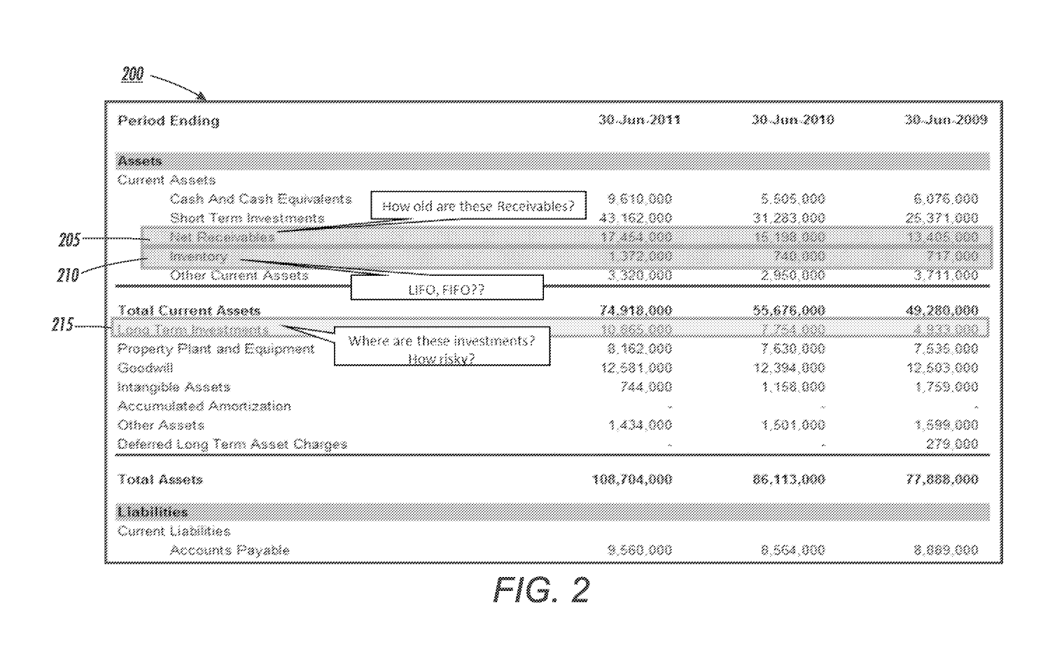

FIG. 2 indicates some examples of a type of additional information related to specific line items that people may want to retrieve from the balance sheet 200 that would be interesting to a financial analyst for some of the specific line items. For instance, the line item “Net Receivables” 205 concerns the money owed to a firm by its customers minus the money that is unlikely to be ever paid. As FIG. 2 indicates, Net Receivables was 17,454,000 for the year 2011. However, this number alone does not provide any information to the analyst about the age distribution of the net receivables. For example, if 40% of the net receivables is more than 120 days old, it is extremely likely that the firm will not be receiving any of that money. Thus, when the analyst goes through the text of the 10-K report and finds out the age distribution of the net receivables, the analyst could adjust the reported number (i.e., 17,454,000) to a new value depending upon the age distribution of the receivables.

The line item “Inventory” 210 concerns the amount of inventory that a firm has. Inventory valuation can be performed by various methods such as LIFO (Last-in First-out), FIFO (First-in First-out), direct identification, average cost, etc. Notably, the number corresponding to the line item “Inventory” 210 can change significantly depending upon the method that was used by the firm for inventory valuation. As FIG. 2 indicates, Inventory 210 was 1,372,000 for the year 2011. However, this number alone does not provide any information to the analyst about the method used for inventory valuation. Thus, when the analyst goes through the text of the 10-K report and finds out which inventory valuation method was used, the analyst could adjust the reported number (i.e., 1,372,000) to a new value depending upon the inventory valuation method.

The line item “Long Term Investments” 215 concerns investments (e.g., stocks, bonds, cash, etc.) that the firm intends to hold for more than one year. As FIG. 2 indicates, long term investments 215 was 10,865,000 for the year 2011, for the specific firm. However, this number alone fails to provide any information to the analyst about the relative risks associated with these long-term investments. For example, how are the investments distributed across stocks, bonds and cash? Are some of the investments in geographically risky/unstable locations such as places that are prone to natural disasters, wars and/or places where the likelihood of fraud is high? Depending upon the answers to such questions, the analyst could adjust the reported number (i.e., 10,865,000) for purposes of meaningful analysis.

FIG. 3 depicts example architecture of the 10-K report contextual linking system 300, according to the present teachings. Line Item Detector 305 is operable to detect the line items based on certain properties pertaining to the line items. For the case of most financial statements including the 10-K, the statement is organized in a well-structured table format with well-delimited rows and columns. The table contains a header indicating the type of information in each column. The table size typically has minimum 2 rows and minimum 2 columns. Each row of the table contains structured data in the following form. The first column can contain either line items or titles of categories of line items. In the present context, only the line items of interest to the analyst are discussed. A line item can be a single word or a phrasal construct denoting the aspect of interest. For each of these, the corresponding following columns contain its corresponding numeric values (one value per column). Thus, for each row of the table corresponding to a line item, there can be a 1 to many mapping between the line item and its values, i.e., one item may have multiple numeric values (minimum 1), each of which being described by the column header it falls into. In order to detect each line item and its corresponding values, the table is parsed, and for each row, the line item from the first column and all its corresponding denominations from the columns that follow are extracted.

Section Header Detector 315 is operable to detect the section headers. The following properties of section headers are used. Section headers tend to be in separate text blocks, i.e., paragraphs, and outside tables. The specification of the document format can be used to detect these headers. For instance in HTML documents, paragraphs are marked up in using specific tags such as <p> or <div>. Section headers tend to not contain multiple sentences and section headers typically are not full sentences, thus they do not contain finite verbs. The detection of the section header includes the detection of the paragraphs by locating the paragraph markers. The candidate paragraphs, which do not contain multiple sentences, are detected by filtering out paragraphs that contain 2 or more dots. Then, a part-of-speech tagging on the candidate paragraphs is executed in order to detect the ones that do not contain verbs.

Line Item 310 and Section Header Shallow Parsers 320 are operable to prepare the detected line items and section headers for linking. Any shallow parser can be used as are known in the art. Shallow parsing executes the following operations. The parts-of-speech are tagged in order to detect the two relevant parts-of-speech that are used by the linking algorithm, which are adjectives and nouns. Lemmatization is performed in order to link different forms of the same lemma (e.g., singular-plural, capital letters-small letters). The adjectives and nouns are then tagged as “head” or “modifier”, since this information is relevant for the linking algorithm. e.g., in “capital stock” “capital” is a modifier and “stock” is a head, or in “trademarks with indefinite lives” trademarks is a head and “lives” is a modifier.

Contextual Linking Engine 335 executes the contextual linking algorithm between the numbers corresponding to the line items in the financial statements and their respective context. The actual semantic link is between the numerical value of the line items and the entire sections under the section headers, but the contextual linking algorithm establishes a link between the line items and the section headers right above the context sections, since a structural analysis that delimits the sections is not supposed. Not all the line items are given a context. The basis of the linking algorithm is the presence of common nouns and/or adjectives in the denomination of the line item and the section header. One line item may have one or several contextual sections, and all the section headers of these sections share at least one noun or adjective with the denominator of the line item. Since the denomination of the line items is not uniform across different companies, some line items appear in most filings, some are specific to the company, no pre-established list of line items are used for the linking. The Contextual Linking Engine 335 compares each line item denomination with each section header, and establishes a link, according to the linking rules that are described below.

The scope of the contextual information in the relevant sections may be identical to the scope of the line items, however it may also be broader or narrower, i.e., the explanations may cover exactly the line item or they may cover broader or narrower content. In all cases, the contextual section headers contain the terms that are explained in the section, and thus the denomination of the line item always appears in the section header, however, variations of the exact wording can happen.

The following example correspondence cases exist between the nouns and adjectives in the denomination of the line items and the contextual section header: (Possible variations of letter cases and singular-plural are neutralized by the shallow parsing). In example 1, the section header and the denomination of the line item are identical: 1 contextual section corresponds exactly to 1 line item: e.g., Other Long-Term Liabilities.

In example 2, the entire denomination of the line item is contained in the section header. In this example, the wording of the section header is more specific than that of the denomination of the line item: e.g., section header: Long-term Debt Obligations—line item: Long-term Debt. Alternatively, the coverage of the contextual section is broader that that of the line item: the denomination of the line item is part of the section header. e.g., section header: Cash, Cash Equivalents, and Marketable Securities—line item 1: Cash, Cash Equivalents line item 2: Marketable Securities.

In example 3, the entire section header is contained in the denomination of the line item. In this example, the wording of the denomination of the line item is more specific than that of the section header. e.g., line item: Property and equipment, net—Property and equipment. Alternatively, the coverage of the contextual section is broader that that of the line item. e.g., section header: Debt—line item: Long-Term Debt.

In example 4, the denomination of the line item and the section header has an intersection, but both contain other words as well. In this example, the common words in the section header and in the line item have the same coverage. e.g., line item: Securities lending payable—section header: Securities lending program. Alternatively, the coverage of the common word in the section header is broader than that of the line item: section header: Cost of Revenues—line item: Prepaid revenue share. Alternatively, the coverage of the common word in the line item is broader than that of the section header: line item: Liabilities and Stockholders' Equity—section header: Other Long-Term Liabilities.

The correspondences listed above always indicate a contextual link in example cases 1-3, but in case 4 the properties of the shared terms needs to be considered in order to decide if the contextual link exists or not. The rules to determine the example case 4 are as follows. First, if the common words have no additional modifiers in either the section header or the line item or in both (e.g. 4.a), then the link is established. Second, if there are two common words, and they are not in direct syntactic dependency, then the link is never established, e.g., Class C capital stock—section header: Net Income Per Share of Class-A and Class B Common Stock.

In all other cases a conditional link is established, and the analyst decides if the link is valid or not, depending on the ontological relationship between the two terms. These cases include the following. The common word(s) is (are) a noun phrase head (with a modifier), but one has an additional modifier, or they have different additional modifiers. The section header may be relevant (e.g. 4.c) or not relevant (e.g. section header: Long-term Debt—line item: Short-term Debt). The common word is a noun phrase head in the section header and a modifier in the line item or vice versa. The section header may be relevant (e.g. 4.b) or not relevant (e.g. HL: income taxes—line item: Accumulated or other Comprehensive Income).

Thus, the output of the linking algorithm is one of the following possibilities: Link=the line item is linked to the section header; No link=the line item is not linked to the section header; and Conditional link=the line item is linked to the SH, but the user needs to validate it.

The linking algorithm operates as follows. If the line item and the section header are identical, then link. If the entire line item is contained in a longer section header, then link. If the entire section header is contained in a longer line item, then link. If both the line item and the section header contain other nouns or adjectives besides their intersection, but among those words there are no additional modifiers of the matching words, then link. If the line item and the section header contain two common nouns and/or adjectives and additional nouns or adjectives, and the two common words are not in direct syntactic dependency relationship with each other, then do not link. In all other cases when there is at least one common noun or adjective between the denominator of a line item and a section header, then allow a conditional link.

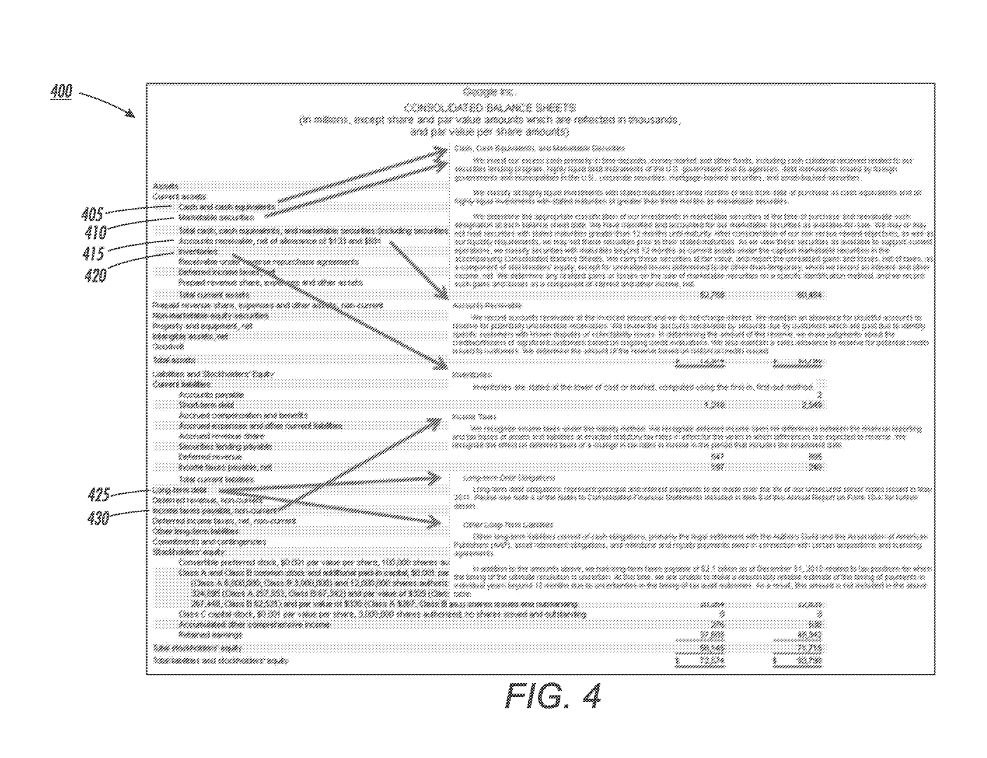

FIG. 4 illustrates a balance sheet and some of the linked contextual information 400, according the present teachings. Line items “Cash and cash equivalents” 405, “Marketable securities” 410, “Accounts receivable, net of allowance of $133 and $581” 415, “Inventories” 420, “Long-term debt” 425, and “Income taxes, non-current” 430 are shown as linked with contextual information, respectively, from the financial statement, as indicated by the respective arrows.

Once the Contextual Linking Engine has completed performing the linking, the results of the linking could be displayed to the user by a personalized “Display Engine” 340 which should be based on the preference rules provided by the user. These preference rules are to be stored in a Display Rules Database 335.

The foregoing description is illustrative, and variations in configuration and implementation can occur to persons skilled in the art. For instance, the various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

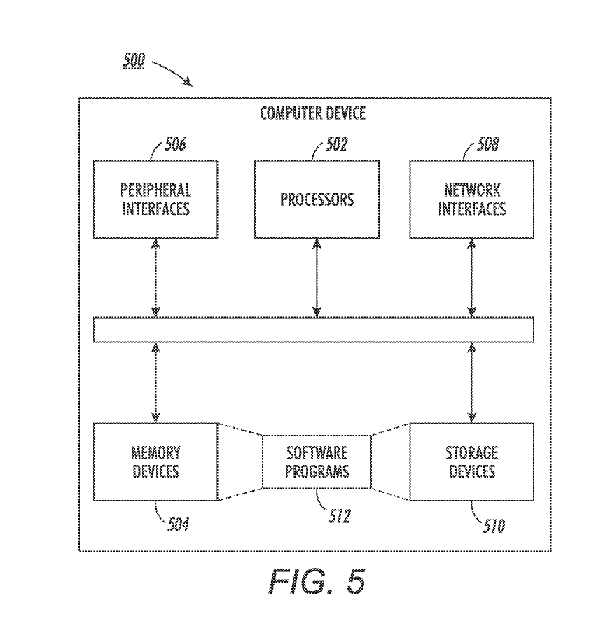

For example, FIG. 5 illustrates an example of a hardware configuration for a computer device 500, that can be used to perform one or more of the processes described above. While FIG. 5 illustrates various components contained in the computer device 500, FIG. 5 illustrates one example of a computer device and additional components can be added and existing components can be removed.

The computer device 500 can be any type of computer devices, such as desktops, laptops, servers, etc., or mobile devices, such as smart telephones, tablet computers, cellular telephones, personal digital assistants, etc. As illustrated in FIG. 5, the computer device 500 can include one or more processors 502 of varying core configurations and clock frequencies. The computer device 500 can also include one or more memory devices 504 that serve as a main memory during the operation of the computer device 500. For example, during operation, a copy of the software that supports the Contextual Linking Engine can be stored in the one or more memory devices 504. The computer device 500 can also include one or more peripheral interfaces 506, such as keyboards, mice, touchpads, computer screens, touchscreens, etc., for enabling human interaction with and manipulation of the computer device 500.

The computer device 500 can also include one or more network interfaces 508 for communicating via one or more networks, such as Ethernet adapters, wireless transceivers, or serial network components, for communicating over wired or wireless media using protocols. The computer device 500 can also include one or more storage device 510 of varying physical dimensions and storage capacities, such as flash drives, hard drives, random access memory, etc., for storing data, such as images, files, and program instructions for execution by the one or more processors 502.

Additionally, the computer device 500 can include one or more software programs 512 that enable the functionality of the Contextual Linking Engine described above. The one or more software programs 512 can include instructions that cause the one or more processors 502 to perform the processes described herein. Copies of the one or more software programs 512 can be stored in the one or more memory devices 504 and/or on in the one or more storage devices 510. Likewise, the data utilized by one or more software programs 512 can be stored in the one or more memory devices 504 and/or on in the one or more storage devices 510.

In implementations, the computer device 500 can communicate with one or more other devices via a network. The network can be any type of network, such as a local area network, a wide-area network, a virtual private network, the Internet, an intranet, an extranet, a public switched telephone network, an infrared network, a wireless network, and any combination thereof. The network can support communications using any of a variety of commercially-available protocols, such as TCP/IP, UDP, OSI, FTP, UPnP, NFS, CIFS, AppleTalk, and the like. The network can be, for example, a local area network, a wide-area network, a virtual private network, the Internet, an intranet, an extranet, a public switched telephone network, an infrared network, a wireless network, and any combination thereof.

The computer device 500 can include a variety of data stores and other memory and storage media as discussed above. These can reside in a variety of locations, such as on a storage medium local to (and/or resident in) one or more of the computers or remote from any or all of the computers across the network. In some implementations, information can reside in a storage-area network (“SAN”) familiar to those skilled in the art. Similarly, any necessary files for performing the functions attributed to the computers, servers, or other network devices may be stored locally and/or remotely, as appropriate.

In implementations, the components of the computer device 500 as described above need not be enclosed within a single enclosure or even located in close proximity to one another. Those skilled in the art will appreciate that the above-described componentry are examples only, as the computer device 500 can include any type of hardware componentry, including any necessary accompanying firmware or software, for performing the disclosed implementations. The computer device 500 can also be implemented in part or in whole by electronic circuit components or processors, such as application-specific integrated circuits (ASICs) or field-programmable gate arrays (FPGAs).

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the processes have been described by examples, the stages of the processes can be performed in a different order than illustrated or simultaneously. Furthermore, to the extent that the terms “including”, “includes”, “having”, “has”, “with”, or variants thereof are used in the detailed description, such terms are intended to be inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection can be through a direct connection, or through an indirect connection via other devices, components, and connections.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method for contextual linking information in a financial report, the method comprising:
obtaining portions of the financial report;
detecting one or more line items in the portions of the financial report based on one or more properties of the one or more line items;
detecting one or more section headers in the portions of the financial report based on one or more properties of the one or more section headers;
parsing, by a processor, the one or more line items and the one or more section headers that are detected; and
linking the one or more line items to the one or more section headers based on the parsing.

2. The computer-implemented method of claim 1, wherein the one or more properties of the one or more line items comprises a table format having defined rows and columns, wherein the table format comprises a header section indicating a type of information in each column.

3. The computer-implemented method of claim 1, wherein the one or more properties of the one or more section headers comprise one or more of: section headers are in separate paragraphs and are outside of a table format; section headers do not contain multiple sentences, and section headers are not full sentences and do not contain finite verbs.

4. The computer-implemented method of claim 1, wherein the detecting one or more section headers in the portions of the financial report based on the one or more properties of the one or more section headers, further comprise:
detecting paragraphs in the portions of the financial report based on locations of paragraph markers;
detecting candidate paragraphs from the paragraphs that are detected that do not contain multiple sentences; and
executing a parts-of-speech tagging operation on the candidate paragraphs that are detected to determine which of the candidate paragraphs contain verbs; and
excluding the candidate paragraphs that are found to contain verbs.

5. The computer-implemented method of claim 1, wherein the parsing the one or more line items and the one or more section headers that are detected, further comprise:
determining a part of speech for a word in a line item or a section header;
lemmatizing the word to link the work to different forms of a same lemma; and
labeling the part of speech for the word with a head tag or a modifier tag.

6. The computer-implemented method of claim 5 wherein the linking the one or more line items to the one or more section headers based on the parsing, further comprise:
determining that section header and denomination of the line item is identical.

7. The computer-implemented method of claim 5 wherein the linking the one or more line items to the one or more section headers based on the parsing, further comprise:
determining that entire denomination of the line header is contained in the section header.

8. The computer-implemented method of claim 5 wherein the linking the one or more line items to the one or more section headers based on the parsing, further comprise:
determining that entire section header is contained in the line item.

9. The computer-implemented method of claim 5 wherein the linking the one or more line items to the one or more section headers based on the parsing, further comprise:
determining that line item and the section header have common elements and contain other words; and
providing a conditional link between the line item and section header.

10. The computer-implemented method of claim 1, further comprising:
providing an output to a user based on the linking.

11. A device comprising:
a memory containing instructions; and
at least one processor, operably connected to the memory, the executes the instructions to perform a method for contextual linking information in a financial report, the method comprising:
obtaining portions of the financial report;
detecting one or more line items in the portions of the financial report based on one or more properties of the one or more line items;
detecting one or more section headers in the portions of the financial report based on one or more properties of the one or more section headers;
parsing, by a processor, the one or more line items and the one or more section headers that are detected; and
linking the one or more line items to the one or more section headers based on the parsing.

12. The device of claim 11, wherein the one or more properties of the one or more line items comprises a table format having defined rows and columns, wherein the table format comprises a header section indicating a type of information in each column.

13. The device of claim 11, wherein the one or more properties of the one or more section headers comprise one or more of: section headers are in separate paragraphs and are outside of a table format; section headers do not contain multiple sentences, and section headers are not full sentences and do not contain finite verbs.

14. The device of claim 11, wherein the detecting one or more section headers in the portions of the financial report based on the one or more properties of the one or more section headers, further comprise:
detecting paragraphs in the portions of the financial report based on locations of paragraph markers;
detecting candidate paragraphs from the paragraphs that are detected that do not contain multiple sentences; and
executing a parts-of-speech tagging operation on the candidate paragraphs that are detected to determine which of the candidate paragraphs contain verbs; and
excluding the candidate paragraphs that are found to contain verbs.

15. A computer readable storage medium comprising instructions for causing one or more processors to perform a method for contextual linking information in a financial report, the method comprising:
obtaining portions of the financial report;
detecting one or more line items in the portions of the financial report based on one or more properties of the one or more line items;
detecting one or more section headers in the portions of the financial report based on one or more properties of the one or more section headers;
parsing, by a processor, the one or more line items and the one or more section headers that are detected; and
linking the one or more line items to the one or more section headers based on the parsing.

16. The computer readable storage medium of claim 15, wherein the one or more properties of the one or more line items comprises a table format having defined rows and columns, wherein the table format comprises a header section indicating a type of information in each column.

17. The computer readable storage medium of claim 15, wherein the one or more properties of the one or more section headers comprise one or more of: section headers are in separate paragraphs and are outside of a table format; section headers do not contain multiple sentences, and section headers are not full sentences and do not contain finite verbs.

18. The computer readable storage medium of claim 15, wherein the detecting one or more section headers in the portions of the financial report based on the one or more properties of the one or more section headers, further comprise:
detecting paragraphs in the portions of the financial report based on locations of paragraph markers;
detecting candidate paragraphs from the paragraphs that are detected that do not contain multiple sentences; and
executing a parts-of-speech tagging operation on the candidate paragraphs that are detected to determine which of the candidate paragraphs contain verbs; and
excluding the candidate paragraphs that are found to contain verbs.
